(19) United States
(12) Patent Application Publication
(10) Pub. No.: US 2009/0286708 A1
(43) Pub. Date: Nov. 19, 2009

(54) CLEANING LIQUID COMPOSITION FOR A SEMICONDUCTOR SUBSTRATE

(75) Inventors: Yutaka Murakami, Soka-shi (JP); Norio Ishikawa, Soka-shi (JP)

Correspondence Address: WOLF GREENFIELD & SACKS, P.C., 600 ATLANTIC AVENUE, BOSTON, MA, 02210-2206, US

(73) Assignee: Kanto Kagaku Kabushiki Kaisha, Tokyo (JP)

(21) Appl. No.: 12/464,176

(22) Filed: May 12, 2009

(30) Foreign Application Priority Data
May 16, 2008 (JP) 2008-130153

(51) Int. Cl. C11D 17/00

(52) U.S. Cl. 510/175

(57) ABSTRACT

It is an object of the present invention to provide a liquid composition for cleaning a semiconductor substrate capable of removing metal impurities on the substrate surface without corroding a copper wiring in the manufacturing process of a semiconductor circuit element.

According to the present invention, by means of a cleaning liquid composition for cleaning a semiconductor substrate, comprising one or more aliphatic polycarboxylic acids and one or more basic amino acids, metal impurities can be removed without corroding the copper wiring in a cleaning process of a semiconductor substrate having a copper wiring, in particular in a cleaning process of a semiconductor substrate in which the copper wiring is exposed after chemical mechanical polishing (CMP).

### FIELD OF THE INVENTION

The present invention relates to a cleaning liquid composition used for cleaning a semiconductor substrate. In further detail, the present invention relates to a cleaning liquid composition for removing metal impurities and the like adhered onto the surface of a substrate in a cleaning process of a semiconductor substrate having a copper wiring in the process for manufacturing a semiconductor, in particular in a cleaning process of a semiconductor substrate in which the copper wiring is exposed after chemical mechanical polishing.

### BACKGROUND OF THE INVENTION

Due to high integration of IC, a trace amount of impurities largely influences the performance and yield of a device, so that a strict contamination control is required. That is, as a result of the requirement for strict contamination control, a variety of cleaning liquids are used in each process of manufacturing of a semiconductor.

In general, as a substrate cleaning liquid for a semiconductor, ammonia-hydrogen peroxide solution-water (SC-1), which is an alkaline cleaning liquid, is used in order to remove particle contaminations, and sulfuric acid-hydrogen peroxide solution, hydrochloric acid-hydrogen peroxide solution (SC-2), dilute hydrofluoric acid and so forth, which are acidic cleaning liquids, are used in order to remove metal contaminations. A variety of cleaning liquids are used alone or in combination in accordance with the purposes.

On the other hand, due to advancing of miniaturization and multilayered wiring structuration of the device, more precise planarization of the substrate surface in each process is required. As a novel technology in the semiconductor manufacturing process, a chemical mechanical polishing (hereinafter, also called “CMP”) technology has been introduced in which a wafer is pressure bonded to the abrasive cloth, called a buff, and rotated while supplying a slurry mixture of abrasive particles and chemical agents so as to combine chemical actions and physical actions, and hereby an insulating film and metal materials are polished and planarized. At the same time, a type of substrate surface to be planarized and materials consisting of slurry have also been changed. The substrate surface after CMP is contaminated by alumina and silica contained in the slurry, particles typified by cerium oxide particle, component materials of the surface to be polished and metal impurities derived from agents contained in the slurry.

These contaminants cause a defect of pattern, poor adhesiveness, and poor electric property; therefore they need to be removed completely before beginning the next step. As general post-CMP cleaning for removing these contaminants, brush cleaning is carried out in which a chemical action of a cleaning liquid and a physical action by a sponge brush made of polyvinyl alcohol and such are used in combination. As a cleaning liquid, alkalis such as ammonia have been conventionally used in order to remove particles. Also, JP, A, 10-72594 and JP, A, 11-131093 suggest technologies using organic acids and complexing agents in order to remove metal contaminants. Further, as a technology for removing metal contaminants and particle contaminants at one time, JP, A, 2001-7071 suggests a cleaning liquid in which organic acids and surfactants are combined.

During the time that the application of CMP has been limited for planarization of interlayer insulation films and connecting pores, there has been no case that materials with inferior chemical resistance are exposed on the substrate surface, and thus it was possible to clean the substrate with an aqueous solution of ammonium fluoride and an aqueous solution of the above-mentioned organic acids. However, since a damascene interconnect technology was introduced as a technology for forming a copper wiring necessary for further speeding up of the response of the semiconductor element, organic films such as aromatic aryl polymers with low dielectric constant, siloxane films such as MSQ (Methyl Silsesquioxane) and HSQ (Hydrogen Silsesquioxane), porous silica film and the like are going to be used as interlayer insulation films. Since these materials do not have sufficient chemical strength as a cleaning liquid, the above-mentioned alkaline liquids and fluorides are restricted.

On the other hand, the liquids using the above-mentioned organic acids are alleged to have low corrosion nature against insulating films with low dielectric constant, which are the most preferable, and heretofore, as post-CMP cleaning liquids, acid series cleaning liquids using organic acids such as oxalic acid and citric acid have predominated. However, since an introduction of a copper as an interconnecting material is fully in progress, in damascene interconnect technology, in which a minute channel is formed on an insulation film and the barrier metal film such as Ta and TaN is formed and further a copper film is formed by plating and the like in order to bury the channel, and thereafter unnecessary copper formed on an insulation film is polished and removed by CMP, following problems exist: Due to miniaturization of the width and thinning of a copper wiring, even if the above-mentioned organic acids are used, 1) slight corrosion of copper surface (film decrease and surface roughening) occurs, and 2) so-called side slit occurs, in which a cleaning liquid contacts with exposed Cu wiring, and the minute corrosion etc. of the wedge-shaped Cu along the interface between barrier metals such as Ta, TaN and Cu occurs, and the reliability of the device is decreased.

As a means for solving such problems, a method in which a corrosion inhibitor is added to a cleaning liquid, and the corrosion of the copper surface is inhibited was used. As corrosion inhibitors, benzotriazole and derivatives thereof are widely known. They are alleged to inhibit corrosion by coordinating a N atom in the structure to a copper atom and forming an insoluble robust hydrophobic film on the surface. However, since this film is robust, the step of removing after cleaning is necessary, which is not preferable. Also, when the film is removed insufficiently and remains on the copper surface, there is a fear that deterioration of electric properties is caused. Further, their biodegradability is low and mutagenicity is also reported, so that there is a problem of safety against environment and human body.

Also, the present inventors have suggested a cleaning liquid comprising aliphatic polycarboxylic acids and reducing substances such as glyoxylic acid, ascorbic acid, glucose, fructose, lactose and mannose, as a cleaning liquid capable of removing metal impurities and the like on a substrate surface without causing corrosion of the copper surface and side slit (JP, A, 2003-332290). Since glyoxylic acid, ascorbic acid, glucose, fructose, lactose and mannose undergo oxidation, it is considered that oxidation and corrosion of copper is thereby inhibited. However, by subsequent researches, it has become clear that even the combination of aliphatic polycarboxylic acids and the above-described reducing substances may not always have a sufficient effect of inhibiting corrosion of copper depending on the condition for process during formation of wiring and the condition for cleaning.

Further, for example, JP, A, 2003-13266 suggests a cleaning agent comprising an amino acid having a thiol group within its molecule or a derivative thereof as a corrosion inhibitor of copper. However, even though an amino acid having a thiol group such as cysteine has high corrosion inhibiting effect for copper, the thiol group within the molecule reacts with a copper to separate out and remains on the copper wiring, and thus this is not preferable as a cleaning agent.

Also, for example, WO 2001/071789 suggests a cleaning agent for a semiconductor surface that does not corrode a copper wiring, comprising particular compounds having a nitrogen atom with an unshared electron pair within the molecule. Example of these compounds are acyclic amino acids such as acidic amino acids, neutral amino acids, basic amino acids and so forth. However, no advantage of using a basic amino acid is particularly shown, and also no example showing the effect of acyclic amino acids themselves is specifically disclosed at all.

Further, for example, JP, A, 2004-94203 suggests a cleaning liquid for removing resists with high corrosion resistance for a copper, comprising an aminocarboxylic acid as an anticorrosive for a copper. Examples of the aminocarboxylic acid are acidic amino acids, neutral amino acids, basic amino acids and so forth. However, though the effect of glycine that is a neutral amino acid at pH 6.0 is disclosed in Examples, no advantage of using a basic amino acid is shown, and further an anticorrosive effect of copper at strong acidic side is not clear.

Also, for example, JP, A, 2006-49881 suggests a composition for cleaning a semiconductor substrate comprising an amino acid compound as an anticorrosive-chelating agent for a tungsten and an aluminum. Examples of the amino acid compound are acidic amino acids, neutral amino acids, basic amino acids and so forth. However, though the effect of glutamic acid that is an acidic amino acid is disclosed in Examples, no advantage of using a basic amino acid is shown, and an anticorrosive effect on copper is insufficient.

As described above, it is an actual state that, by the conventional cleaning liquid for a semiconductor substrate using organic acids, a minute corrosion of a copper wiring surface (reduction in film and surface roughening) and a minute corrosion of the interface where a copper and a dissimilar metal contact (side slit) can not be inhibited sufficiently. Also, though a cleaning agent comprising an amino acid etc. is suggested as an anticorrosive, most of these are neutral amino acids or acidic amino acids. Further, as to the cleaning liquid for the purpose of removing metal impurities on the substrate surface without corroding a copper wiring, the anticorrosive effect for copper in case that organic acids and amino acids coexist has been neither known sufficiently, nor studied.

### DESCRIPTION OF THE INVENTION

### Problems to be Solved by the Invention

Therefore, it is a problem to be solved by the present invention to provide a cleaning liquid composition that does not corrode a copper wiring, and has an excellent removing property of metal impurities adhered onto a substrate surface when cleaning a semiconductor substrate having a copper wiring on the surface, in particular when cleaning a semiconductor substrate in which the copper wiring is exposed after CMP.

### Means for Solving the Problems

The present inventors have, while intensively researching in order to solve the above-described problems, found that the cleaning liquid composition consisting of a specific combination of aliphatic polycarboxylic acids, such as oxalic acid and basic amino acids such as arginine, suppresses corrosion of a copper wiring effectively, and also has an excellent removing ability for metal impurities on the substrate surface, and as a result of a further research, completed the present invention.

That is, the present invention relates to a cleaning liquid composition for cleaning a semiconductor substrate, comprising one or more aliphatic polycarboxylic acids and one or more basic amino acids.

Also, the present invention relates to the above-described cleaning liquid composition, wherein pH is less than 4.0.

Further, the present invention relates to the above-described cleaning liquid composition, wherein the aliphatic polycarboxylic acid is oxalic acid, malonic acid, malic acid, tartaric acid or citric acid.

Also, the present invention relates to the above-described cleaning liquid composition, wherein the above-described basic amino acid is arginine, histidine or lysine.

Further, the present invention relates to the above-described cleaning liquid composition, wherein the concentration of the aliphatic polycarboxylic acids is 0.01 to 30 wt %.

Also, the present invention relates to the above-described cleaning liquid composition, wherein the concentration of the basic amino acids is 0.001 to 10 wt %.

Further, the present invention relates to the above-described cleaning liquid composition, further comprising one or more anionic type or nonionic type surfactants.

Also, the present invention relates to the above-described cleaning liquid composition, which is used for a semiconductor substrate having a copper wiring after chemical mechanical polishing.

Further, the present invention relates to a method for cleaning a semiconductor substrate having a copper wiring after chemical mechanical polishing, wherein the above-described cleaning liquid composition is used.

Though the reason why the cleaning liquid composition of the present invention has higher corrosion inhibiting effect on the copper wiring by comprising basic amino acids than the cleaning liquid comprising a neutral amino acid or an acidic amino acid as a corrosion inhibitor, is not necessarily clear, it is considered that it is because basic amino acids have more nitrogen-containing structures such as amino group in the side chain than a neutral amino acid and an acidic amino acid, so that they coordinate to a copper more strongly than a neutral amino acid and an acidic amino acid, and thus the anticorrosive effect thereof is increased.

### EFFECTS OF THE INVENTION

The cleaning liquid composition of the present invention made it possible that metal impurities adhered onto a substrate surface are removed effectively without damaging a copper wiring in the cleaning step of a semiconductor substrate having a copper wiring in the step of manufacturing a semiconductor, in particular in the cleaning step of a semiconductor substrate in which a copper wiring is exposed after CMP. Also, the cleaning liquid composition of the present invention does not contaminate a substrate by remaining on the copper surface. Therefore, even if miniaturization of devices advances, an excellent substrate can be obtained without influencing on the performance of electric properties by cleaning a substrate with the cleaning liquid composition of the present invention.

### BEST MODE FOR CARRYING OUT THE INVENTION

The present invention is described in the following in detail. The cleaning liquid composition of the present invention is a cleaning liquid composition used for removing metal impurities and fine particles adhered onto the surface of a substrate having a copper wiring in the production of a semiconductor and another electronic device, comprising one or more aliphatic polycarboxylic acids and one or more basic amino acids. In particular, the cleaning liquid composition is used for the cleaning step of a semiconductor substrate in which a copper wiring is exposed after CMP. Also, the liquid composition of the present invention can be applied not only for the above-described cleaning step of a semiconductor substrate in which a copper wiring is exposed after CMP, but also for the step of removing dry etching residues produced during the formation of a damascene interconnect.

Also, the substrate to be cleaned using the cleaning liquid composition of the present invention is a substrate having a copper wiring on the surface that is used in production of a semiconductor and another electronic device. In particular it is a semiconductor substrate in which a copper wiring is exposed after CMP, a semiconductor substrate in which a copper wiring is exposed when an insulating film is dry-etched during the formation of a damascene interconnect and the like.

As aliphatic polycarboxylic acids used for the cleaning liquid composition of the present invention, specifically, dicarboxylic acids such as oxalic acid and malonic acid, and oxycarboxylic acids such as tartaric acid, malic acid and citric acid can be used. More preferably they are oxalic acid and malonic acid. Among these, oxalic acid has a high removing ability for metal impurities, so that it is particularly preferable as aliphatic polycarboxylic acids used for the present invention. Further, one or more of these aliphatic polycarboxylic acids may be comprised in accordance with the application.

The concentration of the aliphatic polycarboxylic acids in the cleaning liquid is appropriately determined by considering the solubility, removing effect for metal impurities and precipitation of crystals; the concentration is preferably 0.01 to 30 wt %, more preferably 0.02 to 20 wt %, and particularly preferably 0.03 to 10 wt %.

Also, as basic amino acids used for the present invention, arginine, histidine and lysine are specifically used, more preferably they are arginine and histidine. Further, one or more of these basic amino acids may be comprised in accordance with application.

The concentration of basic amino acids in the cleaning liquid is appropriately determined by considering the solubility, corrosion inhibiting effect on the copper wiring, and inhibition effect for side slit and so forth; the concentration is preferably 0.001 to 10 wt %, more preferably 0.005 to 5 wt %, and particularly preferably 0.01 to 1 wt %.

From the viewpoint that the copper wiring is not corroded, and the removing ability for metal impurities adhered onto a wafer surface is excellent, the pH of the cleaning liquid composition of the present invention is preferably less than 4.0, and particularly preferably 1.0 to 3.0.

Also, the cleaning liquid composition of the present invention may comprise a surfactant for providing a removing ability for fine particles, and providing an affinity for a hydrophobic film such as Low-k film, to the extent that the above-described effects are not interfered. As a surfactant used for such purpose, anionic and nonionic type surfactants are preferable. Anionic type surfactants are, for example, alkylbenzenesulfonic acid type and salts thereof, alkylphosphate ester type, polyoxyalkylene alkyl phenyl ether sulfonic acid and salts thereof, polyoxyalkylene alkyl ether sulfonic acid and salts thereof, condensation product of naphthalenesulfonic acid, formaldehyde and salts thereof and so on. Further, nonionic type surfactants are, for example, polyoxyalkylene alkyl ether type, polyoxyalkylene alkyl phenyl ether type and so on.

The concentration of the surfactant for obtaining a sufficient particle-removing effect in the cleaning liquid composition of the present invention is preferably 0.0001 to 10 wt %, and particularly preferably 0.001 to 0.1 wt %. Also, one or more of these surfactants may be comprised in accordance with the application.

Further, the cleaning liquid composition of the present invention may comprise further ingredients for preventing corrosion of the copper wiring, or for preventing occurrence of the side slit of copper, to the extent that the above-described effects are not interfered. As ingredients used for such purpose, reducing substances, such as glyoxylic acid, ascorbic acid, glucose, fructose, lactose and mannose are preferable. They exert effects of not only suppressing etching of copper surface, but also suppressing the side slit. Although this mechanism is not clear, it is considered that, since these compounds are reducing substances and undergo oxidation, oxidation and corrosion of copper are prevented. However, although as reducing substances, amines such as hydrazine and hydroxylamine can also be used, they have a tendency of increasing a side slit, so that not all of the reducing substances can be used for the cleaning liquid composition of the present invention.

The concentration of the reducing substances for obtaining a sufficient corrosion inhibiting effect in the cleaning liquid composition of the present invention is preferably 0.0005 to 10 wt %, particularly preferably 0.03 to 5 wt %. Also, one or more of these reducing substances may be comprised in accordance with the application.

Moreover, while usually water is usually used as a solvent for the cleaning liquid composition of the present invention, it may contain an organic solvent for providing an affinity for a hydrophobic film such as a bare silicon and Low-k film, to the extent that the above-described effects are not interfered. As an organic solvent used for such purpose, organic solvents having hydroxyl group and/or ether group are preferable.

According to the cleaning liquid composition of the present invention, the concentration of the organic solvent for providing an affinity for a hydrophobic film such as bare silicon and Low-k film is preferably 0.01 to 50 wt %, particularly preferably 0.1 to 30 wt %. Also, one or more of these organic solvents may be comprised in accordance with the application.

As a cleaning method of the semiconductor substrate having a copper wiring after chemical mechanical polishing using the cleaning liquid composition of the present invention, batch type cleaning in which the substrate is directly dipped in the cleaning liquid, methods such as single wafer cleaning in which the cleaning liquid is supplied for the substrate surface from a nozzle while the substrate is spin rotated can be used. Also, the methods in which a physical cleaning such as brush scrub cleaning by sponge brush made of polyvinyl alcohol and such and megasonic cleaning using high-frequency wave are used in combination with the above-described cleaning methods.

Examples and Comparative examples of the present invention are shown below, and the present invention is explained in more detail. The present invention is, however, not limited to these Examples, and various variations are possible in the scope of not departing from the technical idea of the present invention.

### EXAMPLES

### Measurement of Rate of Dissolution of Copper

Using water as a solvent, cleaning liquids comprising an aliphatic polycarboxylic acid and an amino acid shown in Table 1 were prepared. A silicon wafer having a known surface area to which a copper plating film (film thickness, 16000 angstroms) was formed was cleaned with an acid to expose a clean copper surface. The wafer was subjected to a treatment by dipping in each cleaning liquid at 25° C. for 300 minutes without stirring, and thereafter the wafer was removed. The copper concentration in the cleaning liquid was analyzed by an ICP mass spectroscope (ICP-MS), and the rate of dissolution was calculated from the measured copper concentration. The decrease rate of the thickness of the copper plating film per unit time is represented as the rate of dissolution of copper with the unit “angstroms/minute”. The results are shown in Table 1.

TABLE 1
Results of measurement of the rate of dissolution of copper

| | Cleaning liquid composition | | | | |
|---|---|---|---|---|---|
| | Aliphatic | | | | Rate of |
| | polycarboxylic acid | | Amino acid | | dissolution |
| | | Concentration | | Concentration | (angstroms/ |
| Example No. | Type | (wt %) | Type | (wt %) | minute) |
| Example 1 | Oxalic | 0.14 | Arginine | 0.10 | 0.6 |
| | acid | | | | |
| Example 2 | Oxalic | 0.04 | Arginine | 0.03 | 0.6 |
| | acid | | | | |
| Example 3 | Oxalic | 0.14 | Histidine | 0.10 | 0.5 |
| | acid | | | | |
| Comparative | Oxalic | 0.14 | — | — | 2.3 |
| example 1 | acid | | | | |
| Comparative | Oxalic | 0.04 | — | — | 1.9 |
| example 2 | acid | | | | |
| Comparative | Oxalic | 0.14 | Phenylalanine | 0.10 | 1.0 |
| example 3 | acid | | | | |
| Comparative | Oxalic | 0.14 | Glutamine | 0.10 | 1.0 |
| example 4 | acid | | | | |
| Comparative | Oxalic | 0.14 | Serine | 0.10 | 1.1 |
| example 5 | acid | | | | |
| Comparative | Oxalic | 0.14 | Sarcosine | 0.10 | 1.1 |
| example 6 | acid | | | | |
| Comparative | Oxalic | 0.14 | Glycine | 0.10 | 1.2 |
| example 7 | acid | | | | |
| Comparative | Oxalic | 0.14 | Alanine | 0.10 | 1.2 |
| example 8 | acid | | | | |
| Comparative | Oxalic | 0.14 | Valine | 0.10 | 1.3 |
| example 9 | acid | | | | |
| Comparative | Oxalic | 0.14 | Proline | 0.10 | 1.4 |
| example 10 | acid | | | | |
| Comparative | Oxalic | 0.04 | Serine | 0.10 | 1.1 |
| example 11 | acid | | | | |
| Comparative | Oxalic | 0.04 | Sarcosine | 0.10 | 1.1 |
| example 12 | acid | | | | |

As shown in Table 1, the cleaning liquids comprising only oxalic acid of Comparative examples 1 to 2, and the cleaning liquids comprising oxalic acid and a neutral amino acid or an acidic amino acid of Comparative examples 3 to 12 all show the rate of dissolution of 1 angstrom/minute or more. On the contrary, the cleaning liquids comprising oxalic acid and a basic amino acid of Examples 1 to 3 show the rate of dissolution of 1 angstrom/minute or less, and it can be seen that the basic amino acid is extremely effective for preventing corrosion of copper. In the cleaning step of the semiconductor substrate in which a copper wiring is exposed after CMP in the actual semiconductor manufacturing process, the corrosion of the copper wiring in the order of angstrom may also become a serious problem, and thus the cleaning liquid composition of the present invention is extremely effective for preventing corrosion of the copper wiring.

### Measurement of Surface Roughness of Copper and Evaluation of the Surface Condition

Using water as a solvent, cleaning liquids comprising an aliphatic polycarboxylic acid and an amino acid shown in Table 2 were prepared. A silicon wafer to which a copper sputtered film (film thickness, 2000 angstroms) was formed was cleaned with an acid to expose a clean copper surface. The wafer was subjected to a treatment by dipping in each cleaning liquid at 25° C. for 30 minutes without stirring, and thereafter the wafer was removed. The wafer was then subjected to rinse treatment by flowing extra-pure water, and nitrogen blow-drying was carried out. The surface roughness of copper (average surface roughness Ra) was measured by an atom force microscope (AFM) and the surface contamination property was evaluated by a scanning electron microscope (FE-SEM). The results are shown in Table 2.

TABLE 2
Result of the measurement of the surface roughness of copper and
the evaluation of the surface condition

| | Cleaning liquid composition | | | | | |
|---|---|---|---|---|---|---|
| | Aliphatic | | | | Average | |
| | polycarboxylic acid | | Amino acid | | surface | Surface |
| | | Concentration | | Concentration | roughness | contamination |
| Example No. | Type | (wt %) | Type | (wt %) | Ra (nm) | property |
| — | No treatment by dipping into the cleaning liquid | | | | 0.75 | ◯ |
| Example 1 | Oxalic | 0.14 | Arginine | 0.10 | 0.72 | ◯ |
| | acid | | | | | |
| Example 2 | Oxalic | 0.04 | Arginine | 0.03 | 0.78 | ◯ |
| | acid | | | | | |
| Example 3 | Oxalic | 0.14 | Histidine | 0.10 | 0.79 | ◯ |
| | acid | | | | | |
| Example 4 | Malonic | 5.00 | Histidine | 0.10 | 0.89 | ◯ |
| | acid | | | | | |
| Comparative | Oxalic | 0.14 | — | — | 1.76 | ◯ |
| example 1 | acid | | | | | |
| Comparative | Oxalic | 0.04 | — | — | 1.77 | ◯ |
| example 2 | acid | | | | | |
| Comparative | Oxalic | 0.14 | Glycine | 0.10 | 1.78 | ◯ |
| example 7 | acid | | | | | |
| Comparative | Oxalic | 0.14 | Alanine | 0.10 | 1.36 | ◯ |
| example 8 | acid | | | | | |
| Comparative | Oxalic | 0.14 | Glutamic | 0.10 | 1.70 | ◯ |
| example 13 | acid | | acid | | | |
| Comparative | Oxalic | 0.14 | Cysteine | 0.10 | 6.30 | X |
| example 14 | acid | | | | | |
| Comparative | Malonic | 5.00 | — | — | 1.94 | ◯ |
| example 15 | acid | | | | | |

 (Evaluation criteria of surface contamination property)
◯: Fouling on the copper surface is not recognized
X: Fouling on the copper surface is recognized

As shown in Table 2, with regard to the surface roughness of copper in the cleaning liquids comprising only an aliphatic polycarboxylic acid of Comparative examples 1 to 2 and Comparative example 15, and the cleaning liquids comprising oxalic acid and a neutral amino acid or an acidic amino acid of Comparative examples 7, 8, 13 and 14, Ra values increase as compared to the surface roughness of copper without treatment by dipping into the cleaning liquid, and it can be seen that surface roughening occurs. Further, in the cleaning liquid of Comparative Example 14, in addition to the increase of Ra value, fouling derived from cysteine was recognized on the surface. On the other hand, in the cleaning liquids comprising an aliphatic polycarboxylic acid and a basic amino acid of Examples 1 to 4, the variation of Ra values are extremely small, so that it can be seen that the basic amino acid is extremely effective for preventing corrosion of copper.

### Evaluation of Ability of Removing Metal Impurities

Using water as a solvent, cleaning liquids comprising an aliphatic polycarboxylic acid and an amino acid shown in Table 3 were prepared. A silicon wafer was cleaned with ammonia water (29 wt %)-hydrogen peroxide solution (30 wt %)-water mixture liquid (volume ratio, 1:1:6). The wafer was then contaminated with iron, nickel, copper and zinc by means of spin-coating method so that the surface concentration is 10¹³ atoms/cm². The contaminated wafer was dipped in each cleaning liquid at 25° C. for 3 minutes without stirring, and thereafter the wafer was removed. The wafer was subjected to rinse treatment for 3 minutes by flowing extra-pure water and then dried. The metal concentration on the wafer surface was measured by means of total reflection X-ray fluorescence instrument to evaluate ability of removing metal impurities. The results are shown in Table 3.

TABLE 3
Evaluation results of ability to remove metal impurities

| | Cleaning liquid composition | | | | | | |
|---|---|---|---|---|---|---|---|
| | Oxalic acid | Amino acid | | Metal surface concentration | | | |
| | concentration | | Concentration | (×10¹⁰ atoms/cm²) | | | |
| Example No. | (wt %) | Type | (wt %) | Fe | Ni | Cu | Zn |
| — | Before cleaning | | | 3400 | 4600 | 4400 | 4600 |
| Example 2 | 0.04 | Arginine | 0.03 | 0.8 | 0.3 | 0.3 | Less than |
| | | | | | | | measurement |
| | | | | | | | limit |
| Example 5 | 0.04 | Histidine | 0.03 | 0.3 | 0.5 | 0.2 | Less than |
| | | | | | | | measurement |
| | | | | | | | limit |
| Comparative | 0.04 | — | — | 0.4 | 0.3 | 0.2 | Less than |
| example 2 | | | | | | | measurement |
| | | | | | | | limit |
| Comparative | — | Arginine | 0.03 | 2000 | 60 | 80 | 10 |
| example 16 | | | | | | | |

As shown in Table 3, with the cleaning liquid comprising only a basic amino acid of Comparative example 16, each metal remains in the order of 10¹¹ atoms/cm² or more. On the contrary, the cleaning liquid comprising oxalic acid and a basic amino acid of Examples 2 and 5 have ability to remove metal impurities comparable to the cleaning liquid comprising only oxalic acid of Comparative example 2.

From the results of the above-described Tables 1 to 3, it can be seen that the cleaning liquid composition of the present invention effectively prevents corrosion of a copper wiring, and has an excellent removing ability for metal impurities adhered onto the wafer surface.

### INDUSTRIAL APPLICABILITY

According to the present invention, cleaning a semiconductor substrate having a copper wiring with a cleaning liquid composition comprising one or more aliphatic polycarboxylic acids and one or more basic amino acids enables to remove metal impurities without corroding a copper wiring, and to obtain an excellent substrate without influencing the performance of electric properties. Accordingly, it is useful for the cleaning step of a substrate having a copper wiring in the technical field of manufacturing a semiconductor in which miniaturization advances, in particular for the cleaning step of a semiconductor substrate in which the copper wiring is exposed after chemical mechanical polishing (CMP).

The terms and expressions which have been employed are used as terms of description and not of limitation, and there is no intention in the use of such terms and expressions of excluding any equivalents of the features shown and described or portions thereof, it being recognized that various modifications are possible within the scope of the invention.

All references disclosed herein are incorporated by reference, in particular for the teaching that is referenced hereinabove.

1. A cleaning liquid composition for cleaning a semiconductor substrate, comprising one or more aliphatic polycarboxylic acids and one or more basic amino acids.

2. The cleaning liquid composition according to claim 1, wherein pH is less than 4.0.

3. The cleaning liquid composition according to claim 1, wherein the aliphatic polycarboxylic acid is oxalic acid, malonic acid, malic acid, tartaric acid or citric acid.

4. The cleaning liquid composition according to claim 1, wherein the basic amino acid is arginine, histidine or lysine.

5. The cleaning liquid composition according to claim 1, wherein the concentration of the aliphatic polycarboxylic acids is 0.01 to 30 wt %.

6. The cleaning liquid composition according to claim 1, wherein the concentration of the basic amino acids is 0.001 to 10 wt %.

7. The cleaning liquid composition according to claim 1, further comprising one or more anionic type or nonionic type surfactants.

8. The cleaning liquid composition according to claim 1, which is used for a semiconductor substrate having a copper wiring after chemical mechanical polishing.

9. A method for cleaning a semiconductor substrate having a copper wiring after chemical mechanical polishing, wherein the cleaning liquid composition according to claim 1 is used.
